(19) United States
(12) Patent Application Publication
(10) Pub. No.: US 2024/0017887 A1
(43) Pub. Date: Jan. 18, 2024

(54) Vacuum Storage Bag and Preparation Method Thereof

(71) Applicant: Jiangsu Jinhengxiang Packaging Co., Ltd., Huai'an (CN)

(72) Inventor: Jinxiang Zhang, Jinhu (CN)

(21) Appl. No.: 18/476,361

(22) Filed: Sep. 28, 2023

(30) Foreign Application Priority Data
Sep. 29, 2022 (CN) 202211201651.8

(51) Int. Cl. B65D 30/08; B65D 81/20; B65D 33/25; B32B 27/32; B32B 27/12; B32B 5/02; B32B 27/08; B32B 7/12; B32B 27/16; B32B 37/12; B32B 37/24; B32B 38/00; B31B 70/74; B31B 70/88; B31B 70/16; B31B 70/81; B31B 70/62

(52) U.S. Cl. CPC B65D 29/02; B65D 81/2038; B65D 33/2508; B32B 27/32; B32B 27/12; B32B 5/022; B32B 27/08; B32B 7/12; B32B 27/16; B32B 37/12; B32B 37/24; B32B 38/145; B32B 38/0004; B31B 70/79; B31B 70/88; B31B 70/16; B31B 70/8131; B31B 70/62; B32B 2439/46; B32B 2262/0276; B32B 2255/10; B32B 2255/26; B32B 2037/243; B32B 2323/04; B32B 2329/04; B31B 2170/20

(57) ABSTRACT

The present invention discloses a vacuum storage bag and a preparation method thereof. The vacuum storage bag comprises a bag body, which is equipped with an extraction valve and a sealing zipper; the bag body is composed of an inner film layer and an outer film layer by glue laminating, a blocking layer is arranged on the surface of the inner film layer; and the outer film layer is made of cloth. The vacuum storage bag of the present invention is made of cloth and PE film. The cloth is soft and folding, thick and wear-resistant, not easy to be brittle, and has long service life. In addition, there are many types of cloth and PE film for preparing the vacuum storage bag prepared in this application, which can be selected according to needs, so that the vacuum storage bag prepared has a wider scope of application.

### CROSS-REFERENCE TO RELATED APPLICATIONS

The application claims priority to Chinese patent application No. 202211201651.8 filed Sep. 29, 2022; the disclosure of this prior-filed applications is incorporated herein by reference in its entirety.

### FIELD

The present invention refers to the technical field of vacuum storage bag, in particular to a vacuum storage bag and a preparation method thereof.

### BACKGROUND

The vacuum compression bag, as the name suggests, is just a bag caused by the natural compression of atmospheric pressure by pumping away the air. In short, the vacuum compression bag is a bag mainly used for holding quilts and various types of clothing. The vacuum compression bag has the moisture-proof, mildew-proof, moth-proof and odor-proof characteristics.

The existing materials for making the vacuum compression bag material are divided into two types of combination, one is PE material+nylon material composite. This combination has the following problems: first, PE material is brittle and easy to damage, and nylon material is expensive; second, when the PE material+nylon material are not integrated in the later recovery, they cannot be recycled, and the environmental performance is poor; the second is PE material+PET material composite, the advantage of this combination is that the price is relatively low, but there is also the phenomenon of brittle and easily damaged materials, and the permeability is up to 120 cc m2/24 h; this combination is difficult to be used again after one use, with serious waste.

In view of this, the present invention is specially proposed.

### SUMMARY

The purpose of the present invention is to provide a vacuum storage bag and a preparation method thereof. The vacuum storage bag is made of cloth and PE film. The cloth is soft and folding, thick and wear-resistant, not easy to be brittle, and has long service life. In addition, there are many types of cloth and PE film for preparing the vacuum storage bag prepared in this application, which can be selected according to needs, so that the vacuum storage bag prepared has a wider scope of application.

For realizing the above-mentioned purpose of the present invention, the following technical solution is specifically adopted:
The present invention provides a vacuum storage bag in the first aspect, wherein the vacuum storage bag comprises a bag body, which is equipped with an extraction valve and a sealing zipper;
the bag body is composed of an inner film layer and an outer film layer by glue laminating, a blocking layer is arranged on the surface of the inner film layer;
and the outer film layer is made of cloth.

Preferably, the types of cloth include polyester, cotton and linen, non-woven fabrics and polyester cotton blended.

Preferably, the inner film layer is made of ordinary PE film, reinforced PE film, casting PE film or multi-layer co-extruded PE film.

Preferably, the glue used for gluing is water-based composite glue, hot melt glue, polyurethane glue or oil-based glue.

Preferably, the blocking layer is made from PVA emulsion or other emulsions with blocking effect. The permeability can be reduced to be less than or equal to 10 cc m2/24 h, and the blocking effect is 5 times that of PA+PE products and more than 12 times that of PET+PE products.

The present invention provides a preparation method of the vacuum storage bag in the second aspect. The preparation method comprises the following steps:
(a) performing corona treatment for the PE film, applying the water-based PVA emulsion on the surface of the PE film, and then drying in the drying tunnel to obtain the inner film layer;
(b) solidifying and forming the cloth and inner film layer by means of glue laminating;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag.

Preferably, in Step (a), the temperature of drying in the drying tunnel is 60˜90° C., the length of the drying tunnel is not less than 15 m, and the moving speed is 40˜50 m/min.

Preferably, in Step (b), the solidifying and forming temperature is 45˜60° C., and the time is 12˜36 h.

Preferably, in Step (b), when the glue used for gluing is hot melt glue, glue laminating for the cloth and the inner film layer specifically includes the following steps:
melting the hot melt glue, and applying it on the surface of the cloth, and then laminating the post-corona inner film layer on the surface of the cloth;
when the glue used for gluing is water-based composite glue or polyurethane glue, glue laminating for the cloth and the inner film layer specifically includes the following steps:
applying the water-based composite glue or the polyurethane glue on the surface of the cloth, drying in the drying tunnel, and then laminating the post-corona inner film layer on the surface of the cloth.

Preferably, in Step (d), the temperature of the sealing hot knife of the bag making machine during the bottom and side sealing is 150˜180° C., and the temperature of the sealing hot knife of the bag making machine during the zipper sealing is 160˜190° C.

Compared with the prior art, the present invention at least has the beneficial effects as follows:

The vacuum storage bag of the present invention is made of cloth and PE film. The cloth is soft and folding, thick and wear-resistant, not easy to be brittle, and has long service life. In addition, there are many types of cloth and PE film for preparing the vacuum storage bag prepared in this application, which can be selected according to needs, so that the vacuum storage bag prepared has a wider scope of application.

The vacuum storage bag of the present invention can be glued with multiple glues, and it is suitable for use on the equipment with multiple different performances. Meanwhile, it also adapts to the requirements of environment at different temperatures. In addition, this product can separate the cloth from the PE film by water immersion, and the film can be recycled.

### DETAILED DESCRIPTION

The following is detailed description on the embodiment of the technical solution in the present invention by combining with the embodiment. The following embodiments are only used for more clearly describing the technical solution of the present invention. So, they are only taken as the examples, but cannot be for limiting the protection scope of the present invention.

It shall be noted that, unless otherwise stated, the technical or scientific terms used in this application shall have the usual meaning understood by technicians skilled in the field of the present invention.

The embodiment of the present invention provides a vacuum storage bag, wherein the vacuum storage bag comprises a bag body, which is equipped with an extraction valve and a sealing zipper;
the bag body is composed of an inner film layer and an outer film layer by glue laminating, a blocking layer is arranged on the surface of the inner film layer;
and the outer film layer is made of cloth.

The vacuum storage bag of the present invention is made of cloth and inner film layer. The cloth is more flexible, not easy to be brittle, and has long service life. In addition, a blocking layer is arranged on the surface of the inner film layer, which can block the air, realize vacuuming and achieve the purpose of vacuum storage.

In some embodiments, the types of cloth include polyester, cotton and linen, non-woven fabrics and polyester cotton blended. There are many types of cloth, which can be selected according to needs, so that the vacuum storage bag prepared has a wider scope of application.

In some embodiments, the inner film layer is made of ordinary PE film, reinforced PE film, casting PE film or multi-layer co-extruded PE film. There are many types of PE film, which can be selected according to needs, so that the vacuum storage bag prepared has a wider scope of application.

In some embodiments, the glue used for gluing is water-based composite glue, hot melt glue, polyurethane glue or oil-based glue. The vacuum storage bag of the present invention can be glued with multiple glues, and it is suitable for use on the equipment with multiple different performances. Meanwhile, it also adapts to the requirements of environment at different temperatures.

In Embodiment I, the blocking layer is made from PVA emulsion or other emulsions with blocking effect; it can play a role in blocking the gas from entering the bag body, and the permeability is ≤10 cc m2/24 h.

The embodiment of the present invention also provides a preparation method of the vacuum storage bag in the second aspect. The preparation method comprises the following steps:
(a) performing corona treatment for the PE film, applying the water-based PVA emulsion on the surface of the PE film, and then drying in the drying tunnel to obtain the inner film layer; after the test, the permeability of the inner film layer obtained after applying the water-based PVA solution is within 10 cc m2/24 h, which is many times higher than that of nylon film 50 cc m2/24 h and PET film 120 cc m2/24 h. In addition, the length of the drying tunnel is not less than 15 m. As the high temperature resistance of the PE film is poor, the regular temperature of the drying channel is controlled at 60˜90° C., and the drying effect is achieved through the length of the drying channel. In addition, the PE film is not the stretched film, containing about 0.5˜1.5 cm shrinkage, and due to low drying temperature, the linear production speed must be controlled at about 40˜50 meters/min;
(b) solidifying and forming the cloth and inner film layer by means of glue laminating; after the cloth and the PE film are combined by glue, the glue needs to be activated and solidified by temperature, so that the two layers of materials are tightly bonded together; the regular temperature of the drying room is at 45˜60° C., and the curing time is 12˜36 h;
(c) Printing pattern on the surface of the cloth to obtain cloth plastic film; making the product appearance more beautiful through printing, with selling points; and
(d) cutting on the cloth plastic film to install the extraction valve, and then adjusting the width and length according to different sizes, and applying the oil to the sealing hot knife section of the bag making machine for sealing the edge, bottom and zipper to obtain the vacuum storage bag.

In some embodiments, in Step (b), when the glue used for gluing is hot melt glue, glue laminating for the cloth and the inner film layer specifically includes the following steps:
melting the hot melt glue, and applying it on the surface of the cloth, and then laminating the post-corona inner film layer on the surface of the cloth;
when the glue used for gluing is water-based composite glue or polyurethane glue, glue laminating for the cloth and the inner film layer specifically includes the following steps:
applying the water-based composite glue or the polyurethane glue on the surface of the cloth, drying in the drying tunnel, and then laminating the post-corona inner film layer on the surface of the cloth.

In some embodiments, in Step (d), the temperature of the sealing hot knife of the bag making machine during the bottom and side sealing is 150˜180° C., and the temperature of the sealing hot knife of the bag making machine during the zipper sealing is 160˜190° C.

The following is detailed description for the technical solution of the present invention through specific embodiments.

### Embodiment 1

This embodiment provides a vacuum storage bag, wherein the vacuum storage bag comprises a bag body, which is equipped with an extraction valve and a sealing zipper;
the bag body is composed of an inner film layer and an outer film layer by glue laminating, a blocking layer is arranged on the surface of the inner film layer;
the outer film layer is made of polyester cloth;
the inner film layer is made of ordinary PE film;
the glue used for gluing is hot melt glue; and
the blocking layer is made from PVA emulsion.

### Embodiment 2

This embodiment provides a vacuum storage bag, wherein the vacuum storage bag comprises a bag body, which is equipped with an extraction valve and a sealing zipper;
the bag body is composed of an inner film layer and an outer film layer by glue laminating, a blocking layer is arranged on the surface of the inner film layer;
the outer film layer is made of non-woven fabric;
the inner film layer is made of reinforced PE film;
the glue used for gluing is water-based composite glue; and
the blocking layer is made from PVA emulsion.

### Embodiment 3

This embodiment provides a vacuum storage bag, wherein the vacuum storage bag comprises a bag body, which is equipped with an extraction valve and a sealing zipper;
the bag body is composed of an inner film layer and an outer film layer by glue laminating, a blocking layer is arranged on the surface of the inner film layer;
the outer film layer is made of cotton and linen cloth;
the inner film layer is made of multi-layer co-extruded PE film;
the glue used for gluing is polyurethane glue; and
the blocking layer is made from PVA emulsion.

### Embodiment 4

This embodiment provides a preparation method of the vacuum storage bag in the second aspect. The preparation method comprises the following steps:
(a) performing corona treatment for the PE film, applying the water-based PVA emulsion on the surface of the PE film, and then drying in the drying tunnel to obtain the inner film layer, wherein the temperature of drying in the drying tunnel is 70˜90° C., the length of the drying tunnel is not less than 15 m, and the moving speed is 50 m/min.
(b) melting the hot melt glue, and applying it on the surface of the cloth, and then laminating the post-corona inner film layer on the surface of the cloth, wherein the solidifying and forming temperature is 45° C., and the time is 36 h;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag, wherein the temperature of the sealing hot knife of the bag making machine during the bottom and side sealing is 150° C., and the temperature of the sealing hot knife of the bag making machine during the zipper sealing is 160° C.

### Embodiment 5

This embodiment provides a preparation method of the vacuum storage bag in the second aspect. The preparation method comprises the following steps:
(a) performing corona treatment for the PE film, applying the water-based PVA emulsion on the surface of the PE film, and then drying in the drying tunnel to obtain the inner film layer, wherein the temperature of drying in the drying tunnel is 60˜80° C., the length of the drying tunnel is not less than 15 m, and the moving speed is 40 m/min.
(b) melting the hot melt glue, and applying it on the surface of the cloth, and then laminating the post-corona inner film layer on the surface of the cloth, wherein the solidifying and forming temperature is 60° C., and the time is 12 h;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag, wherein the temperature of the sealing hot knife of the bag making machine during the bottom and side sealing is 180° C., and the temperature of the sealing hot knife of the bag making machine during the zipper sealing is 190° C.

### Embodiment 6

This embodiment provides a preparation method of the vacuum storage bag in the second aspect. The preparation method comprises the following steps:
(a) performing corona treatment for the PE film, applying the water-based PVA emulsion on the surface of the PE film, and then drying in the drying tunnel to obtain the inner film layer, wherein the temperature of drying in the drying tunnel is 70˜90° C., the length of the drying tunnel is not less than 15 m, and the moving speed is 50 m/min.
(b) solidifying and forming the cloth and inner film layer by means of glue laminating, wherein applying the water-based composite glue or the polyurethane glue on the surface of the cloth, drying in the drying tunnel, and then laminating the post-corona inner film layer on the surface of the cloth, solidifying and forming, wherein the solidifying and forming temperature is 45° C., and the time is 36 h;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag, wherein the temperature of the sealing hot knife of the bag making machine during the bottom and side sealing is 160° C., and the temperature of the sealing hot knife of the bag making machine during the zipper sealing is 170° C.

### Embodiment 7

This embodiment provides a preparation method of the vacuum storage bag in the second aspect. The preparation method comprises the following steps:
(a) performing corona treatment for the PE film, applying the water-based PVA emulsion on the surface of the PE film, and then drying in the drying tunnel to obtain the inner film layer, wherein the temperature of drying in the drying tunnel is 60˜80° C., the length of the drying tunnel is not less than 15 m, and the moving speed is 40 m/min.
(b) solidifying and forming the cloth and inner film layer by means of glue laminating, wherein applying the water-based composite glue or the polyurethane glue on the surface of the cloth, drying in the drying tunnel, and then laminating the post-corona inner film layer on the surface of the cloth, solidifying and forming, wherein the solidifying and forming temperature is 60° C., and the time is 12 h;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag, wherein the temperature of the sealing hot knife of the bag making machine during the bottom and side sealing is 170° C., and the temperature of the sealing hot knife of the bag making machine during the zipper sealing is 180° C.

The vacuum storage bag prepared by the embodiment of the present invention is made of cloth and PE film. The cloth is soft and folding, thick and wear-resistant, not easy to be brittle, and has long service life. In addition, there are many types of cloth and PE film for preparing the vacuum storage bag prepared in this application, which can be selected according to needs, so that the vacuum storage bag prepared has a wider scope of application.

Finally, it shall be noted that: the above embodiments are only used to describe the technical solution of the present invention and not to limit it. Although the present invention is described in detail by referring to the above-mentioned embodiments, ordinary technicians in this field shall understand that it may modify the technical solution recorded in each of the above-mentioned embodiments or replace some or all technical features equivalently. Such modifications or replacements shall not detract the essence of the corresponding technical solutions from the scope of the technical solutions in the embodiments of the present invention, which shall be covered by the scope of the Claims of the present invention.

1. A vacuum storage bag, wherein the vacuum storage bag comprises a bag body, which is equipped with an extraction valve and a sealing zipper;
the bag body is composed of an inner film layer and an outer film layer by glue laminating, a blocking layer is arranged on the surface of the inner film layer;
and the outer film layer is made of cloth.

2. The vacuum storage bag according to claim 1, wherein the types of cloth include polyester, cotton and linen, non-woven fabrics and polyester cotton blended.

3. The vacuum storage bag according to claim 1, wherein the inner film layer is made of ordinary PE film, reinforced PE film, casting PE film or multi-layer co-extruded PE film.

4. The vacuum storage bag according to claim 1, wherein the glue used for gluing is water-based composite glue, hot melt glue, polyurethane glue or oil-based glue.

5. The vacuum storage bag according to claim 1, wherein the blocking layer is made from PVA emulsion or other emulsions with blocking effect.

6. A preparation method of the vacuum storage bag in any of claim 1, wherein the preparation method comprises the following steps:
(a) performing corona treatment for the PE film, applying the water-based PVA emulsion on the surface of the PE film, and then drying in the drying tunnel to obtain the inner film layer;
(b) solidifying and forming the cloth and the inner film layer by means of glue laminating;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag.

7. A preparation method of the vacuum storage bag in claim 2, wherein the preparation method comprises the following steps:
(a) performing corona treatment for the PE film, applying the water-based PVA emulsion on the surface of the PE film, and then drying in the drying tunnel to obtain the inner film layer;
(b) solidifying and forming the cloth and the inner film layer by means of glue laminating;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag.

8. A preparation method of the vacuum storage bag in claim 3, wherein the preparation method comprises the following steps:
(a) performing corona treatment for the PE film, applying the water-based PVA emulsion on the surface of the PE film, and then drying in the drying tunnel to obtain the inner film layer;
(b) solidifying and forming the cloth and the inner film layer by means of glue laminating;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag.

9. A preparation method of the vacuum storage bag in claim 4, wherein the preparation method comprises the following steps:
(a) performing corona treatment for the PE film, applying the water-based PVA emulsion on the surface of the PE film, and then drying in the drying tunnel to obtain the inner film layer;
(b) solidifying and forming the cloth and the inner film layer by means of glue laminating;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag.

10. A preparation method of the vacuum storage bag in claim 5, wherein the preparation method comprises the following steps:
(a) performing corona treatment for the PE film, applying the water-based PVA emulsion on the surface of the PE film, and then drying in the drying tunnel to obtain the inner film layer;
(b) solidifying and forming the cloth and the inner film layer by means of glue laminating;
(c) printing pattern on the surface of cloth to obtain cloth plastic film; and
(d) cutting on the cloth plastic film to install the extraction valve, and then using a bag making machine for sealing the edge, bottom and zipper to obtain the vacuum storage bag.

11. The preparation method according to claim 6, wherein in Step (a), the temperature of drying in the drying tunnel is 60˜90° C., the length of the drying tunnel is not less than 15 m, and the moving speed is 40˜50 m/min.

12. The preparation method according to claim 6, wherein in Step (b), the solidifying and forming temperature is 45˜60° C., and the time is 12˜36 h.

13. The preparation method according to claim 6, wherein in Step (b), when the glue used for gluing is hot melt glue, glue laminating for the cloth and the inner film layer specifically includes the following steps:
melting the hot melt glue, and applying it on the surface of the cloth, and then laminating the post-corona inner film layer on the surface of the cloth;
when the glue used for gluing is water-based composite glue or polyurethane glue, glue laminating for the cloth and the inner film layer specifically includes the following steps:
applying the water-based composite glue or the polyurethane glue on the surface of the cloth, drying in the drying tunnel, and then laminating the post-corona inner film layer on the surface of the cloth.

14. The preparation method according to claim 6, wherein in Step (d), the temperature of the sealing hot knife of the bag making machine during the bottom and side sealing is 150˜180° C., and the temperature of the sealing hot knife of the bag making machine during the zipper sealing is 160˜190° C.
